(19) United States
(12) Patent Application Publication
(10) Pub. No.: US 2017/0292623 A1
(43) Pub. Date: Oct. 12, 2017

(54) HEAT STAKED SOLENOID VALVE ASSEMBLY AND METHOD

(71) Applicant: Schaeffler Technologies AG & Co. KG, Herzogenaurach (DE)

(72) Inventor: David Becker, White Lake, MI (US)

(73) Assignee: Schaeffler Technologies AG & Co. KG, Herzogenaurach (DE)

(21) Appl. No.: 15/093,897

(22) Filed: Apr. 8, 2016

(51) Int. Cl. F16K 27/02; F16K 31/06

(52) U.S. Cl. CPC F16K 27/029; F16K 31/0655

(57) ABSTRACT

A method of assembling a solenoid valve assembly as well as a solenoid valve assembly are provided. A polymeric valve housing having a plurality of housing posts extending from one end is assembled to a metallic intermediate plate by inserting the posts through corresponding openings on the flange. The housing posts are then at least one of heat or ultrasonically staked over the openings to connect the metallic intermediate plate to the polymeric valve housing. A metallic solenoid housing with solenoid components therein is then placed over the metallic intermediate plate and the metallic housing is crimped onto the metallic intermediate plate. Additional valve and solenoid components are inserted during the assembly process.

### FIELD OF INVENTION

The present invention relates to solenoid actuator assemblies, and in particular to solenoid actuated valve assemblies.

### BACKGROUND

Solenoid valves are known in the art and are used in various applications for controlling a fluid flow. A solenoid valve includes a combination of two functional units: a solenoid and a valve. The solenoid includes an electrical coil, a core or armature that is actuated by the magnetic flux generated by the coil upon energization, a spring which returns the armature to a de-energized position, and a housing in which these components are located. The valve includes a valve housing typically including one or more valve ports, and a poppet which is moveable within the valve housing in order to open or close the one or more ports. Typically the valve housing is a metal part and requires machining at least at the sealing surfaces and valve seats. The coil is typically a wound copper wire that, upon energization, creates the magnetic flux. The core or armature is made of a magnetic material and upon energization of the coil is moved via the magnetic flux to an actuating position. The spring acts on the armature or the poppet to return the armature to its de-energized position. Typically, the armature is located in a tube that is closed at one end that is located within the coil and acts as a guide for the armature.

Since the solenoid valve is a combination of two functional parts, one issue that is always faced is the need to make a strong, reliable, and low cost physical connection between the solenoid housing, which is typically a metallic component, and the valve housing. There is also the need to reduce costs to the extent possible while maintaining the same functionality and reliability for the overall solenoid valve assembly.

### SUMMARY

In one aspect, a method of assembling a solenoid valve assembly is provided. The method includes providing a polymeric valve housing having a plurality of housing posts extending from one end, and inserting the posts through corresponding openings on a metallic intermediate plate. The housing posts are then at least one of heat or ultrasonically staked over the openings to connect the metallic intermediate plate to the polymeric valve housing. A metallic solenoid housing with solenoid components therein is then placed over the metallic intermediate plate and the metallic housing is crimped onto the metallic intermediate plate. This type of assembly ensures that the metallic elements are crimped onto other metallic elements rather than onto a polymeric element to avoid damage to the polymeric element as well as provide a firm assembly with sufficient structural integrity for the overall solenoid valve assembly.

In one preferred arrangement, the metallic intermediate plate is a mounting flange.

The method may further include inserting a poppet as well as the valve plunger or rocket into the polymeric valve housing.

In one preferred aspect, a groove is located on the top of the polymeric valve housing in an area of the housing posts in a region of the metallic intermediate plate. The method further includes inserting an O-ring into the groove with the O-ring extending above the groove.

In a further aspect, the metallic intermediate plate includes an actuator opening, the method further comprises placing a metallic tube having a tube flange at one end through the actuator opening, with an armature of the solenoid being located in the metallic tube for contacting the valve plunger or rocket, locating the flange over the O-ring and installing the metallic intermediate plate with the tube flange on the valve housing with the housing posts extending through corresponding openings, and compressing the O-ring during the staking of the ends of the housing posts over the openings.

In another aspect, the method further includes inserting poles and a coil into the metallic solenoid housing prior to placing the metallic solenoid housing over the metallic intermediate plate and crimping the metallic solenoid housing onto the metallic intermediate plate.

In another aspect, a solenoid valve assembly that is assembled according to the method is provided. The solenoid valve assembly preferably includes the polymeric valve housing with the plurality of housing posts that extend from one end as well as the metallic intermediate plate having openings corresponding to the housing posts, with the housing posts being staked over the openings. A metallic solenoid housing is located on the metallic intermediate plate on an opposite side from the polymeric valve housing and has crimped portions that engage the metallic intermediate plate. Preferably, the poppet is located in the polymeric valve housing and a solenoid armature actuates the poppet.

Further, as noted above, preferably a groove is provided on the top of the polymeric valve housing in an area of the housing posts in a region of the metallic intermediate plate, and an O-ring is located in and extends above the groove. Preferably, an actuator opening is provided in the metallic intermediate plate. A metallic tube is provided with a tube flange at one end, and an armature is located the metallic tube that contacts the rocket for moving the poppet. The tube flange is located on the top of the polymeric valve housing with the tube flange located between the O-ring and the metallic intermediate plate. The metallic tube extends through the actuator opening and acts as a guide for the armature as well.

The O-ring provides a vertical force against the tube flange of the metallic tube in order to press it tightly against the bottom of the metallic intermediate plate providing a pre-load against the heat-staked ends of the housing post as well as its normal sealing function.

Poles and a coil for the solenoid are located in the metallic solenoid housing surrounding the armature.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is a cross-sectional view of a solenoid valve assembly in accordance with one embodiment.

FIGS. 2-6 show an assembly sequence of the solenoid valve assembly according to FIG. 1.

FIG. 7 is a cross-sectional view showing the valve housing, metallic intermediate plate, and metallic armature tube to prior to heat staking.

FIG. 8 is a perspective view, in cross section, showing the heat staked valve housing, metallic intermediate plate, and metallic armature tube in an assembled state.

FIG. 9 is a perspective view of the assembly shown in FIG. 8.

### DETAILED DESCRIPTION OF THE PREFERRED EMBODIMENTS

Certain terminology is used in the following description for convenience only and is not limiting. The words “front,” “rear,” “upper,” and “lower” designate directions in the drawings to which reference is made. The words “inwardly” and “outwardly” refer to directions toward and away from the parts referenced in the drawings. “Axially” refers to a direction along an axis of the valve plunger or rocket or the solenoid armature. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

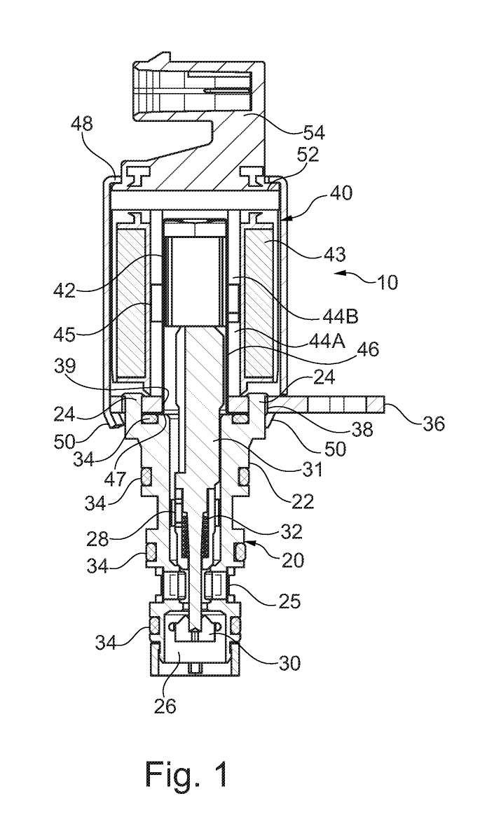

Referring to FIG. 1, a solenoid valve assembly 10 according to the present invention is shown. The solenoid valve assembly 10 includes a valve assembly 20 along with a solenoid assembly 40. The valve assembly 20 preferably includes a polymeric valve housing 22 having a plurality of housing posts 24 extending from one end. The valve housing 22 also includes at least one valve port 25, and in the embodiment illustrated herein, two valve ports, 25, 26. Filters may be installed over these valve ports. A sealing body 28 is preferably located on a valve rocket or plunger 31 and a moveable poppet 30 is located on the end of the valve rocket or plunger 31. Moving the plunger 31 downwardly moves the poppet 30 from the seat located in the housing 22.

Preferably, a plurality of O-rings 34 are located on the outside of the polymeric valve housing 22 in a plurality of grooves in order to allow the housing 22 to be sealed within a receiving opening, for example in a cylinder head, engine block, or other component in which fluid lines that deliver or receive fluid from or to the valve ports 25, 26 are located.

The valve housing 22 is preferably made of a thermoplastic material and in one preferred embodiment is formed of a glass-fiber reinforced PPS. This can include 30%, 40% or more of glass-fiber in order to improve the tensile strength of the valve housing 22 and the posts 24. This allows the valve housing 22 to be molded to a near net shape, reducing both cost and machining time in comparison to metal valve housings. Other suitable polymeric materials can also be used, for example a glass-fiber reinforced PEEK material.

A metallic intermediate plate 36 with corresponding openings 38 is located over the housing posts 24. In a preferred embodiment, the metallic intermediate plate 36 is a mounting flange that can be used to mount the solenoid valve assembly 10. The metallic intermediate plate 36 preferably also includes an actuator opening 39 in which a metallic tube 46 having a closed end at one end and an annular flange 47 at the other end is located. Preferably, the flange 47 is located between the metallic intermediate plate 36 and the polymeric valve housing 22, as shown in FIG. 1, and contacts an O-ring 34 provided in an area of the housing post 24. This O-ring 34 is located in a groove on top of the polymeric valve housing 22 in proximity to the housing post 24 and is compressed during the at least one of heat or ultrasonic staking of the ends of the housing posts 24 over the openings 38 to connect the metallic intermediate plate 36 to the polymeric valve housing 22. Preferably, the metallic tube 46 is made of a stainless steel material and is deep drawn.

Preferably, the solenoid 40 includes an armature 42 located within the metallic tube 46 and in the assembled position, the armature 42 contacts the valve rocket or plunger 31. Annular solenoid poles 44a, 44b, are located around the metallic tube 46 and preferably include a resilient spacer or crush ring 45 there-between. As shown in detail in FIG. 4, this can be a rigid spacer and an O-ring or can be a deformable spacer that provides a pre-load upon assembly of the solenoid 40 to the valve 20 and metallic intermediate plate 36. A coil 43 is located around the poles 44a, 44b. The solenoid housing 48, which is preferably a metallic housing, and more preferably deep drawn, is located over the coil assembly 43 and includes mounting tabs 50 which can be crimped around the metallic intermediate plate 36, as shown in FIG. 1, in order to mount the solenoid 40 to the valve 20. Preferably, a yoke 52 is located above the coil assembly 43 along with an overmold connection 54 which can include a plug for connecting wiring from the coil assembly 43 to a suitable controller.

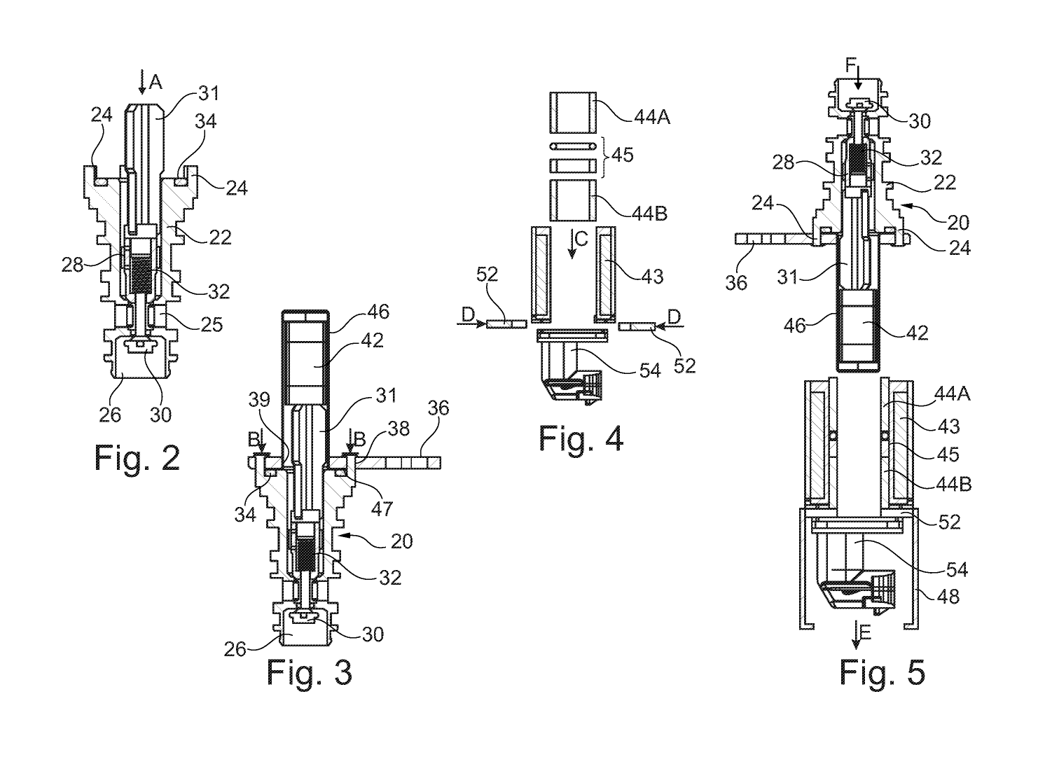

Referring now to FIGS. 2-6, a preferred method of assembling the solenoid valve assembly 10 is shown. This method includes providing the polymeric valve housing 22 having the plurality of housing post 24 extending from one end. Preferably, the valve rocket or plunger 31 along with the sealing body 28 and the return spring 32 are assembled in the valve housing 22 as indicated by arrow A in FIG. 2, and as well the poppet 30 being connected to the end of the plunger 31 and the an O-ring 34 being inserted in the groove on top of the valve housing 22 in the region of the housing posts 24.

As shown in FIG. 3, the housing posts 24 are inserted through the corresponding openings 38 in the metallic intermediate plate 36. Preferably, the metallic tube 46 that has the tube flange 47 at one end is inserted through the actuator opening 35 in the metallic intermediate plate 36 prior to installation on the housing posts 24. As indicated by arrows B in FIG. 3, once the metallic intermediate plate 36 is located over the housing post 24, the ends of the housing post 24 are at least one of heat or ultrasonically staked over the openings 38 to connect the metallic intermediate plate to the polymeric valve housing 22. During this operation, the O-ring 34 is at least partially compressed against the flange 47 at the end of the metallic tube 46. The specific requirements for the heat or ultrasonic staking will vary depending on the material of the valve housing 22 as will be recognized from the present disclosure by those of ordinary skill in the art.

As shown in FIG. 4, preferably the poles 44a, 44b with the resilient spacer or crush ring 45 located therebetween are inserted into the coil assembly 43 as indicated by arrow C. The yoke 52, illustrated here as being provided as two separate pieces, is then installed, preferably by the pieces being inserted radially as indicated by arrow D. The overmold assembly 54 preferably includes the coil assembly 43.

As shown in FIG. 5, the coil assembly 43 along with the poles 44a, 44b, the elastic spacer or crush ring 45, the yoke 52, and the overmold connection 54 are dropped into the solenoid housing 48, as indicated by arrow E. The assembled valve 20 which is connected to the metallic intermediate plate 36 as well as the metallic tube 46 in which the armature 42 is guided is then inserted within the openings in the poles 44a, 44b as indicated by arrow F in FIG. 5.

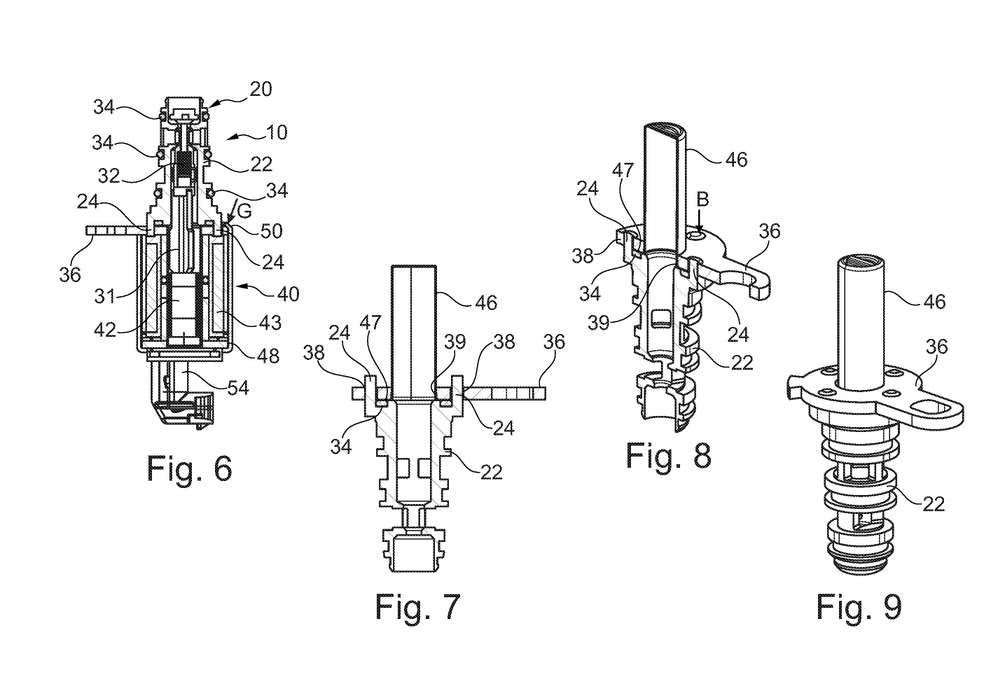

As shown in FIG. 6, once assembled the tabs 50 of the metallic solenoid housing 48 are then crimped onto the metallic intermediate plate 36, as indicated by arrow G, providing a firm metal-to-metal connection.

While two tabs 50 are shown in FIG. 1 and only one is shown in FIG. 6, those skilled in the art will recognize that the number of tabs 50 on the metallic housing 48 that are crimped onto the metallic intermediate plate 36 can be varied. Preferably, there are at least three tabs 50. These can be equally spaced or the spacing may vary.

As shown in FIG. 6, the additional O-rings 34 then installed onto the valve housing 22 in the associated grooves to complete the illustrated embodiment of the solenoid valve assembly.

Referring now to FIGS. 7-9, the staking of the housing post 24 of the polymeric valve housing 22 over the openings 38 in the metallic intermediate plate 36 is shown in detail. As shown in FIGS. 7-9, preferably there are four housing posts 24 and four of the corresponding openings 38 in the metallic intermediate plate 36. The shape and size of the housing posts 24 are preferably optimized for manufacturability and functionality Once assembled, the heat and/or ultrasonic staking of the housing post 24 is carried out as indicated by arrow B in FIG. 8. As shown, due to the installation of the metallic tube 46 with the annular flange 47 through the actuator opening 39 and the metallic intermediate plate 36, the flange 47 contacts the O-ring 34 located on top of the valve housing 22 in the area of the housing posts 24. The O-ring 34, which originally extended above the groove, is compressed by the flange 47 of the metallic tube 46 during the staking operation. The compressing of the O-ring 34 provides two functions in that it pre-loads the connection of the valve housing 22 against the metallic mounting flange 36 in the event of any eventual creep of the polymeric material of the valve housing 22. Additionally, it provides a sealing function.

While one valve configuration is illustrated, those skilled in the art will recognize that different valve configurations for different operations can be provided.

The present assembly allows for lower cost and easier assembly of a solenoid valve 10 due to the drop in assembly of the components and crimping of the metallic solenoid housing 48 to the metallic intermediate plate 36 after the polymeric valve housing 22 has been at least one of heat or ultrasonically staked to the metallic intermediate plate 36.

It is to be appreciated and will be apparent to those skilled in the art that many physical changes, only a few of which are exemplified in the detailed description, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A method of assembling a solenoid valve assembly, comprising:
providing a polymeric valve housing having a plurality of housing posts extending from one end;
inserting the housing posts through corresponding openings on a metallic intermediate plate;
at least one of heat or ultrasonically staking ends of the housing posts over the openings to connect the metallic intermediate plate to the polymeric valve housing; and
placing a metallic solenoid housing over the metallic intermediate plate and crimping the metallic housing onto the metallic intermediate plate.

2. The method of claim 1, further comprising:
inserting a poppet and a rocket into the polymeric valve housing.

3. The method of claim 2, wherein a groove is located on a top of the polymeric valve housing in an area of the housing posts in a region of the metallic intermediate plate, the method further comprising inserting a O-ring in the groove, the O-ring extending above the groove.

4. The method of claim 3, wherein the metallic intermediate plate includes an actuator opening, the method further comprising placing a metallic tube having a tube flange at one end through the actuator opening, with an armature of the solenoid being located in the metallic tube for contacting the rocket, locating the tube flange over the O-ring and installing the metallic intermediate plate with the tube flange on the valve housing with the housing posts extending through corresponding openings, and compressing the O-ring during the staking of the ends of the housing posts over the openings.

5. The method of claim 4, further comprising inserting poles and a coil into the metallic solenoid housing prior to placing the metallic solenoid housing over the metallic intermediate plate and crimping the metallic solenoid housing onto the metallic intermediate plate.

6. The method of claim 4, wherein the metallic intermediate plate comprises a mounting flange.

7. A solenoid valve assembly assembled according the method of claim 1.

8. A solenoid valve assembly, comprising:
a polymeric valve housing having a plurality of housing posts extending from one end;
a metallic intermediate plate having openings corresponding to the housing posts, the housing posts being staked over the openings; and
a metallic solenoid housing located on the metallic intermediate plate on an opposite side from the polymeric valve housing and having crimped portions that engage the metallic intermediate plate.

9. The solenoid valve assembly of claim 8, further comprising
a poppet located in the polymeric valve housing, and a rocket contacting the poppet.

10. The solenoid valve assembly of claim 9, further comprising
a groove located on a top of the polymeric valve housing in an area of the housing posts in a region of the metallic intermediate plate, and an O-ring located in and extends above the groove.

11. The solenoid valve assembly of claim 10, further comprising
an actuator opening in the metallic intermediate plate, a metallic tube with a tube flange at one end, an armature located the metallic tube that contacts the rocket, the tube flange being located on the top of the polymeric valve housing with the tube flange located between the O-ring and the metallic intermediate plate, and the metallic tube extends through the actuator opening.

12. The solenoid valve assembly of claim 10, further comprising poles and a coil surrounding the armature located in the metallic solenoid housing.

13. The solenoid valve assembly of claim 10, the metallic intermediate plate comprises a mounting flange.
